(19) United States
(12) Patent Application Publication
(10) Pub. No.: US 2016/0264273 A1
(43) Pub. Date: Sep. 15, 2016

(54) Automatic Grading, Sorting and Packaging System

(71) Applicant: NPK Packaging, LLC, Tacoma, WA (US)

(72) Inventor: Gordon Gerber, Tacoma, WA (US)

(73) Assignee: NPK Packaging, LLC, Tacoma, WA (US)

(21) Appl. No.: 15/067,947

(22) Filed: Mar. 11, 2016

Related U.S. Application Data
(60) Provisional application No. 62/133,013, filed on Mar. 13, 2015.

(51) Int. Cl. B65B 35/34; B07B 13/02; B65B 43/50; B65B 39/00; B65C 3/26; B07B 1/12; B07B 15/00

(52) U.S. Cl. CPC B65B 35/34; B07B 1/12; B07B 13/02; B07B 15/00; B65B 39/007; B65C 3/26; B65B 43/50

(57) ABSTRACT

Provided is a system for grading, sorting and packaging articles. The system includes a receiving load cell for weighing an incoming bulk article to be inventoried, a hopper which receives the incoming bulk article for grading and sorting, at least one tray for grading, sorting and aligning the article, at least one vibratory machine, a carousel housing at least two or more load cells which contain a bag for receiving graded and sorted product, a sensor for weighing graded and sorted product placed within the bag, a bagger machine for disposing bags within the load cells on the carousel and a label machine for printing data related to the product onto a label which is applied to the bags.

### I. BACKGROUND

A. Technical Field

Provided is an automatic grading, sorting and packaging system. Also provided is a corresponding apparatus and method related to the automatic grading, sorting and packaging system. The automatic grading, sorting and packaging system may be used to grade, sort and package variously sized articles.

B. Description of Related Art

Product packaging can be a labor intensive endeavor, particularly when the product to be packaged must first be separated from a bulk article that is purchased from a farm or other locality. In order to separate a product to be packaged from the bulk article a grading and sorting system is typically used to break apart the bulk article into smaller pieces, separate the pieces from each other according to size and package the variously sized articles within bags. Such grading and sorting systems employ the use of hoppers, conveyors and vibratory motion to grade and sort the bulk article. In certain industries, however, it may be desirable to track the bulk article throughout the grading and sorting system to account for the total amount of bulk product that is processed including any remnants from the bulk article that are not processed. It may also be desirable to grade and sort the bulk article into pieces which are small enough to automatically fit within an opening of a bag without the need for human manipulation of the graded and sorted product. Moreover, it may also be desirable to provide a grading and sorting system which is run by software which directs a specific or pre-set amount of graded and sorted product to be placed within a package and which times the operation of the various components of the grading and sorting system so that they are synchronized. Such synchronization may allow for a pre-set amount of graded and sorted product to be packaged within a bag which has already been labeled with data related to the amount of graded and sorted product. The present disclosure provides various embodiments of a system and method which may achieve these results.

### II. SUMMARY

Provided is an automatic grading, sorting and packaging system. The system includes: a receiving load cell for weighing an incoming bulk article to be inventoried; a hopper which receives the incoming bulk article for grading and sorting; a first tray positioned under the hopper, which receives the bulk article as it passes through the hopper, wherein the first tray includes a plurality of indentations which form a plurality of grooves within the first tray; a second tray positioned below the first tray, which receives graded and sorted product from the first tray, wherein the second tray includes a plurality of indentations which form a plurality of grooves within the tray; a third tray positioned below the second tray, wherein the third tray comprises variously sized channels allowing graded and sorted product having a size within the dimensions of the channels to enter into the channels; at least one vibratory machine connected to at least one of the first tray, the second tray and the third tray which causes at least one of the first tray, second tray and third tray to vibrate; a carousel housing at least two or more load cells positioned below the third tray, wherein the load cells contain a bag positioned therein for receiving graded and sorted product from a particularly sized channel of the third tray and wherein the load cells further comprise a sensor for weighing graded and sorted product placed within the bag; a bagger machine for disposing bags within the load cells on the carousel prior to disposal of the product from the channels of the third trays in the load cell; a label machine for applying data related to the inventoried bulk article and the graded and sorted product onto a label which is applied to bags prior to disposal of the bags by the bagger machine onto the load cell of the carousel, wherein inventory data is encoded on the label through one of the following: an identification number, a bar code and a quick release code; and a computer programmed to execute the steps of: recording and saving data related the weight of the bulk article as it is measured in the receiver load cell within the internal memory of a computer, referred to as the “weight-in”; recording and saving data related to the weight of the graded and sorted product as is it measured in all of the load cells within the carousel within the internal memory of a computer, referred to as the “weight-out”; calibrating the automatic grading, sorting and packaging system so that the “weight in” of the bulk article is equal to the total “weight out” of the graded and sorted product contained within the bags of the respective load cells; instructing the label machine to print a label including the “weight-in” of the bulk product and the “weight-out” of the graded and sorted product prior to insertion of the graded and sorted product into the bag.

According to one aspect of the disclosed system, the forces applied by the at least one vibratory machine are micro-vibratory forces.

According to another aspect of the disclosed system, the first tray is positioned at an incline.

According to another aspect of the disclosed system, a dump scale assembly is positioned below the first tray to receive graded and sorted product falling off the first tray; the dump scale assembly includes a container which is pivotable along an axis so that the weight of the graded and sorted product entering into the retainer causes the retainer to pivot and dump the graded and sorted product onto the second tray.

According to another aspect of the disclosed system, the second tray is a v-tray which is pivotable along an axis.

According to another aspect of the disclosed system, the second tray is a v-tray having an interior end and an outer end; the v-tray receives graded and sorted product directly from the first tray; and, the v-tray is pivotable along an axis so that the weight of the graded and sorted product entering the v-tray causes the v-tray to pivot along the axis so that the interior end of the v-tray is pivoted in a downward position.

According to another aspect of the disclosed system, the first tray vibrates at a rate slower than the second tray and the third tray.

According to another aspect of the disclosed system, the second tray vibrates at a rate which is twice as fast as the third tray in order to further separate and align the graded and sorted product.

According to another aspect of the disclosed system, the channels within the third tray are v-shaped.

According to another aspect of the disclosed system, the v-shaped channels are angled downward from a first end of the third tray to a second end of the third tray allowing the graded and sorted product to pass through the channels and into the load cell containing the bag for packaging.

According to another aspect of the disclosed system, the third tray is pivotable along an axis to allow graded and sorted product to pass through the channels within the third tray into the bag positioned within the load cell.

According to another aspect of the disclosed system, the graded and sorted product which is passed through the channel has a size which permits entry within a bag opening without causing bridging of the graded and sorted product within the channel.

According to another aspect of the disclosed system, the graded and sorted product which is passed through the channel has a width and girth which permits entry within a bag opening without causing bridging of the graded and sorted product within the channel.

According to another aspect of the disclosed system, the third tray comprises four channels.

According to another aspect of the disclosed system, the four channels have a width of one inch, two inches, three inches and four inches respectively.

According to another aspect of the disclosed system, the carousel comprises four load cells each of which may be positioned under the four channels respectively.

According to another aspect of the disclosed system, the labeling device operates by creating labels for up to three bags ahead from the current label being applied to a bag within the system.

According to another aspect of the disclosed system, the computer is programmed to execute the steps of recording and saving data related to the location of purchase of the bulk article, the date and time of receipt of the bulk article, the date and time of purchase of the bulk article, the order number of the bulk article, the specific type or strain of bulk article, an employee identification number of a user entering data and performing grading and sorting operations on the system, the purchase code of the bulk article, comments, the brand name of the bulk article purchased, the estimated time to market of the bulk article, the price paid per pound or unit of the bulk article within the internal memory of the computer.

Also provided is an automatic grading, sorting and packaging system. The system includes: a receiving load cell for weighing an incoming bulk article to be inventoried; a hopper which receives the incoming bulk article for grading and sorting; a first tray positioned under the hopper, which receives the bulk article as it passes through the hopper, wherein the first tray includes a plurality of indentations which form a plurality of grooves within the first tray; a second tray positioned below the first tray, which receives graded and sorted product from the first tray, wherein the second tray includes a plurality of indentations which form a plurality of grooves within the tray; a third tray positioned below the second tray, wherein the third tray comprises variously sized channels allowing graded and sorted product having a size within the dimensions of the channels to enter into the channels; at least one vibratory machine connected to at least one of the first tray, the second tray and the third tray which causes at least one of the first tray, second tray and third tray to vibrate; a carousel housing at least two or more load cells positioned below the third tray, wherein the load cells contain a bag positioned therein for receiving graded and sorted product from a particularly sized channel of the third tray, further wherein the graded and sorted product passed through the channel has a size which permits entry within a bag opening without causing bridging of the graded and sorted product within the channel; a bagger machine for disposing bags within the load cells on the carousel prior to disposal of the product from the channels of the third trays in the load cell; and a label machine for applying data related to the inventoried bulk article and the graded and sorted product onto a label which is applied to bags prior to disposal of the bags by the bagger machine onto the load cell of the carousel, wherein inventory data is encoded on the label through one of the following: an identification number, a bar code and a quick release code.

Also provided is a method for automatic grading, sorting and packaging system. The method includes the steps of: receiving a bulk article to be inventoried and measuring the weight of the bulk article on a receiving load cell; inserting the bulk article within a hopper for separating the bulk article into smaller pieces; allowing the bulk article to pass through an aperture at a bottom portion of the hopper to fall on a first tray positioned under the hopper, wherein the first tray includes a plurality of indentations which form a plurality of grooves within the first tray; applying vibratory forces to the first tray allowing the bulk article to be separated along the grooves within the first tray into graded and sorted product, wherein the vibratory forces on the first tray cause the graded and sorted product to travel towards a second tray; allowing the graded and sorted product to fall onto a second tray positioned below the first tray, wherein the second tray includes a plurality of indentations which form a plurality of grooves within the tray for further separation and alignment of the graded and sorted product, applying vibratory forces to the second tray allowing the graded and sorted article to be further separated along the grooves within the second tray and wherein the vibratory forces on the second tray cause the graded and sorted product to travel towards a third tray; allowing the graded and sorted product to fall onto a third tray positioned below the second tray, wherein the third tray includes a plurality of variously sized channels; applying vibratory forces to the third tray allowing the graded and sorted product having a size within the dimensions of a particular channel to enter into the channel and fall towards a load cell positioned below the channel, wherein at least two load cells are positioned within a carousel below the third tray and a bag within the load cells receives graded and sorted product having a size which permits entry within an opening of the bag without causing bridging of the channel; recording the weight of the graded and sorted product within the bag in the load cell through use of a sensor within the load cell; allowing the carousel to rotate the load cell when it is filled to the appropriate pre-set weight and position a subsequent load cell under the channel; removing the bag filled with graded and sorted product from the load cell on the carousel thereby rendering the load cell empty; using a label machine for applying data related to the inventoried bulk article and the graded and sorted product onto a label and applying the label to a bag prior to disposal of the bag by the bagger machine onto the empty load cell on the carousel, wherein inventory data is encoded on the label through one of the following: an identification number, a bar code and a quick release code; and rotating the carousel so that the load cell without a bag is positioned adjacent a dump window on a bagger machine and allowing the bagger machine to dispose a bag within the empty load cell on the carousel prior to disposal of the product from the channels of the third trays in the load cell; and using a computer programmed to execute the steps of: recording and saving data related the weight of the bulk article as it is measured in the receiver load cell within the internal memory of a computer, referred to as the “weight-in”; recording and saving data related to the weight of the graded and sorted product as is it measured in all of the load cells within the carousel within the internal memory of a computer, referred to as the “weight-out”; calibrating the automatic grading, sorting and packaging system so that the “weight in” of the bulk article is equal to the total “weight out” of the graded and sorted product contained within the bags of the respective load cells; instructing the label machine to print a label including the “weight-in” of the bulk product and the “weight-out” of the graded and sorted product prior to insertion of the graded and sorted product into the bag.

### III. BRIEF DESCRIPTION OF THE DRAWINGS

FIG. 1 is a front end view of an exemplary Automatic Grading, Sorting and Packaging System.

FIG. 2 is a side view of various components of an exemplary grade and sort system and a cross-sectional front end view of various components of an exemplary feed and packaging system for an Automatic Grading, Sorting and Packaging System.

FIG. 3 is a cross-sectional side view of various components of an exemplary feed and packaging system for an Automatic Grading, Sorting and Packaging System.

FIG. 4 is a side view of an exemplary package dump air cylinder for an Automatic Grading, Sorting and Packaging System.

FIG. 5 is a top end view of an exemplary Automatic Grading, Sorting and Packaging System.

FIG. 6 is a cross-sectional side view of an exemplary Automatic Grading, Sorting and Packaging System.

FIG. 7 is a back end view of an exemplary Automatic Grading, Sorting and Packaging System.

FIG. 8 is a top end plan view of an exemplary carousel and bagger machine.

FIG. 9 is a cross-sectional elevated view of the infeed end of an exemplary tray for an Automatic Grading, Sorting and Packaging System.

FIG. 10 is a cross-sectional view of an exemplary tray positioned above a vibratory machine within an Automatic Grading, Sorting and Packaging System.

FIG. 11 is a cross-sectional view of an exemplary tray for an Automatic Grading, Sorting and Packaging System.

FIG. 12 is a cross-sectional view of an exemplary tray for an Automatic Grading, Sorting and Packaging System.

FIG. 13 is a cross-sectional view of an exemplary tray for an Automatic Grading, Sorting and Packaging System.

FIG. 14 is a cross-sectional view of an exemplary tray for an Automatic Grading, Sorting and Packaging System.

FIG. 15 is a cross-sectional side view of an exemplary Automatic Grading, Sorting and Packaging System.

FIG. 16 is a cross-sectional top view of an exemplary load cell for an Automatic Grading, Sorting and Packaging System.

FIG. 17 is a cross-sectional top view of an exemplary bag for an Automatic Grading, Sorting and Packaging System.

FIG. 18 is a cross-sectional top view of an exemplary load cell containing a bag for an Automatic Grading, Sorting and Packaging System.

FIG. 19 is a cross-sectional side view of an exemplary load cell for an Automatic Grading, Sorting and Packaging System.

FIG. 20 is a side view of an exemplary load cell for an Automatic Grading, Sorting and Packaging System.

FIG. 21 is a back end view of an exemplary Automatic Grading, Sorting and Packaging System.

FIG. 22 is a flow diagram of the various processes and components for operation of an exemplary Automatic Grading, Sorting and Packaging System.

### IV. DETAILED DESCRIPTION

Provided is a system for automatic grading, sorting and packaging articles. Also provided is an apparatus and method for automatically, grading, sorting and packaging articles. The automatic grading, sorting and packaging system provides an effective way to grade, sort and package articles separated or originating from a bulk stock while at the same time tracking the articles from the point of entry into the system up to the point of packaging. The automatic grading, sorting and packaging system also effectively and efficiently grades and sorts the articles to a size sufficient to pass through a chute into a package without causing bridging at the opening of the chute.

In certain embodiments, the system is a two part system comprising a grade and sort system and a feed and packaging system. The grade and sort system is capable of receiving a bulk article, grading that article into different sizes and lengths and sorting the graded article according to size and length. Articles which are graded are transported through a feed system through the use of micro-vibratory forces for placement into specifically designated bags for packaging. These micro-vibratory forces are applied by vibratory machines to the various trays of the system. The micro-vibratory forces cause the bulk article to separate into differently sized pieces and position themselves along various grooves or channels within the trays. The micro-vibratory forces also cause the article pieces to align and elongate themselves so that article pieces of specific lengths may pass through specifically sized channels within a tray for packaging within a particular bag. The channels themselves further assist in aligning and creating elongation of the product as the product cascades down or over different levels within the system. The bags may be housed within the load cells of a carousel unit which rotates around the tray containing the channels. As the load cell is positioned under or aligned with a particular channel, the graded and sorted article may be caused to pass through the channel and a chute into the appropriate bag. In certain embodiments, the specific dimensions (e.g., the width) of the channels may be designed in conjunction with the size of the opening of the bag. This is to ensure that only graded and sorted products having appropriately sized width and girth for passage through the opening of a bag are capable of passing through the channels. This design prevents bridging of the graded and sorted product between the chute and the bag. For example, in certain embodiments, the channels may have a width of 1.34 inches to ensure that only graded and sorted products within that size fit within the channels and pass through the opening of the bag. If products having a width larger than 1.34 inches were permitted to pass through the channels, bridging of the product between the chute and the bag would occur, thereby blocking passage of products through the channel into the bag.

In further embodiments, the micro-vibratory forces may be applied by vibratory machines which are integrated with the second tray. In such embodiments, the second tray may be stationary and have a 5 degree angle relative to its horizontal axis. This allows the incorporation of a vibratory conveyer system with the vibratory sorting system.

The disclosed system also includes a bag labeling apparatus and process and software for entering and tracking data related to a particular bulk article from the moment it is received and inventoried to the moment it is graded, sorted and packaged. The overall process begins when the bulk article is received by the purchaser. The bulk article is weighed by a receiving load cell within the system. This weight is recorded within the software and is characterized as the “weight in” of the bulk article. Data related to the origins of the bulk article such as the farm where it was purchased from, the type and strain of bulk article purchased, time and date of the order, shipping data related to the order and the time and date of receipt of the order are also entered into the software. This data is transmitted by the software to a label machine which uses the data to create a label containing at least some of this data for a bag that is to receive the graded and sorted product. Thus, the disclosed system allows for the creation of labels for bags prior to the packaging of the bags with graded and sorted product.

The process of receiving, weighing and recording data related to the bulk article may be referred to as a bulk density inventory control system. After recording data related to the bulk article, the bulk article may be subsequently fed or processed through the Automatic Grading, Sorting and Packaging System or it may be stored in inventory for later processing. When an order for a certain amount and type of product is received, the bulk density inventory control system allows the user to retrieve the bulk article from inventory and place it through the grade and sort system and the feed and packaging system of the Automatic Grading, Sorting and Packaging System. The sort and grade system and the feed system break down the bulk article into an appropriately sized product for a particular bag opening and align the product for packaging within the bag. The broken down product passes through various channels within the feed system, exits the feed system through a chute and falls into a bag housed within a load cell on a carousel.

In certain embodiments, the grade and sort and feed system include three trays or vibratory conveyors. The first tray may, in certain embodiments, comprise a flat deck having a plurality of indentations which form various grooves within the tray. The second tray may, in certain embodiments, be positioned below the first tray and comprise at least one v-tray also having a plurality of indentations which form various grooves within the tray. The v-tray may be angled downward from a pivot point so that the interior end of the v-tray faces a third tray which is positioned below the v-tray. The outer end of the v-tray may include a pivot allowing the v-tray to be angled downward towards the third tray. The third tray includes variously sized channels allowing graded and sorted product of specific sizes to pass through into a bag for packaging. In certain embodiments, the channels within the third tray may comprise v-channels which are angled downward from a first end of the third tray to a second end of the third tray. This angled decline of the channels allows graded and sorted product to pass through the channels, through a chute and into a bag for packaging. In certain embodiments the first tray vibrates at a slower rate than the second and third trays. This allows for the initial breaking apart of the bulk article. In further embodiments, the second tray vibrates at a speed that is twice that of the third tray containing the channels. This allows for further separation of the product into smaller pieces of various individual lengths as well as alignment of the graded and sorted product before it enters the channels in the third tray.

In certain embodiments, the second tray and third tray may be integrated within a sort table. In further embodiments, interchangeable screens may be located at the beginning of the sort table upstream from the second tray in such a position that product received from the first tray must pass through these screens as it enters the second tray. This allows for the passage of particulates that are smaller than the screen size onto the second tray. After passing through the screens, product is then moved through the sorting tray separation process performed by the second and third trays.

As mentioned above, the bulk article is graded and sorted into a product which is packaged within bags positioned within load cells of a carousel unit. In certain embodiments, carousel operates by positioning the load cells under different sized channels of a tray. The load cells may include a female receptacle for catching product from the channels. In certain embodiments, a bag is positioned within a female receptacle of a particular load cell for receiving product from a particular channel. A chute is typically employed to transfer product from a channel to a bag within a particular load cell. Before a bag can receive product from a particular channel, the bag must be positioned within the load cell. In certain embodiments, this is accomplished through use of a bagger machine. Therefore, in certain embodiments, the carousel is designed to receive timed delivery of bags from the bagger machine. This may be accomplished through the use of software which times the delivery of the bags from the bagger machine to the load cells on the carousel. In certain embodiments, the labeling device operates by creating labels for up to three bags ahead from the current label being applied to a bag within the system.

Before the bagger machine inserts a bag within a particular load cell, it may be desirable to apply a label to a particular bag. Accordingly, in certain embodiments, the bagger machine works in conjunction with a label machine to apply a printed label onto a bag before the bag is inserted within a particular load cell. Through the use of software in communication with the label machine, the label applied to the bag may contain data related to “weight in” of the bulk article and the weight of the product to be inserted within the particular bag referred to as the “weight out” of the graded and sorted product. As mentioned above, in certain embodiments, the grading and sorting system may include four different sized channels for grading and sorting different sized product. In such embodiments, the grading and sorting system may also include four different load cells within the carousel for receiving graded and sorted product from these four channels. These four load cells may further contain weighing sensors or devices to register and record the weight of the product that is inserted within the bags contained within the respective load cells. In such embodiments, the system is calibrated so that the “weight in” of the bulk article is equal to the “weight out” of the product contained in the respective bags of the four load cells. Thus, in certain embodiments, the system may be described as being calibrated to zero, meaning that the “weight-in” of the bulk article is equal to the “weight out” of the graded and sorted product as measured by the load cells. Accordingly, the disclosed software not only tracks the weight of the product as it enters and exits the system to ensure that all product is accounted for and that no product is lost through the grading and sorting process but it also controls the separation, distribution and packaging of graded and sorted product into the bags on the load cells of the carousel.

The grading, sorting and packaging system through use of the software tracking and accountability system ensures that only the specific weight listed on the bag label is inserted within the respective bag that is to be packaged. This may be accomplished through the use of sensors or a weighing device within the load cell. When a particular weight is reached, an instruction may be sent to software controlling the grading and sorting apparatus to stop flow of product through a particular channel and allow the bag within the load cell to proceed to the final packaging step.

In certain embodiments, the channels within the grading and sorting system may be used to sort product into four different categories. For example, the product may be sorted into four different categories defined by their length such as one inch, two inches, three inches and four inches. This may be accomplished through the use of appropriately sized channels (e.g., one inch, two inches, three inches and four inches).

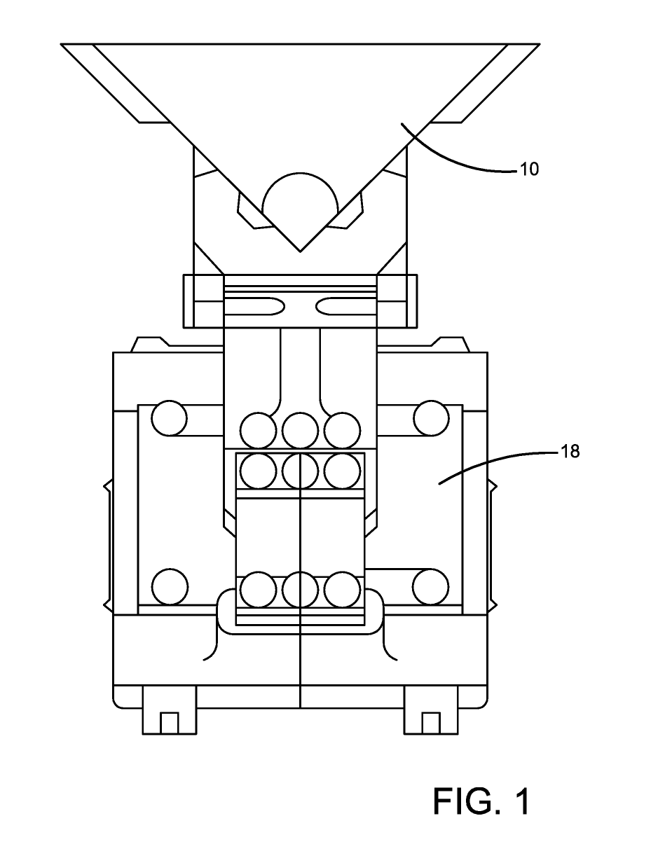

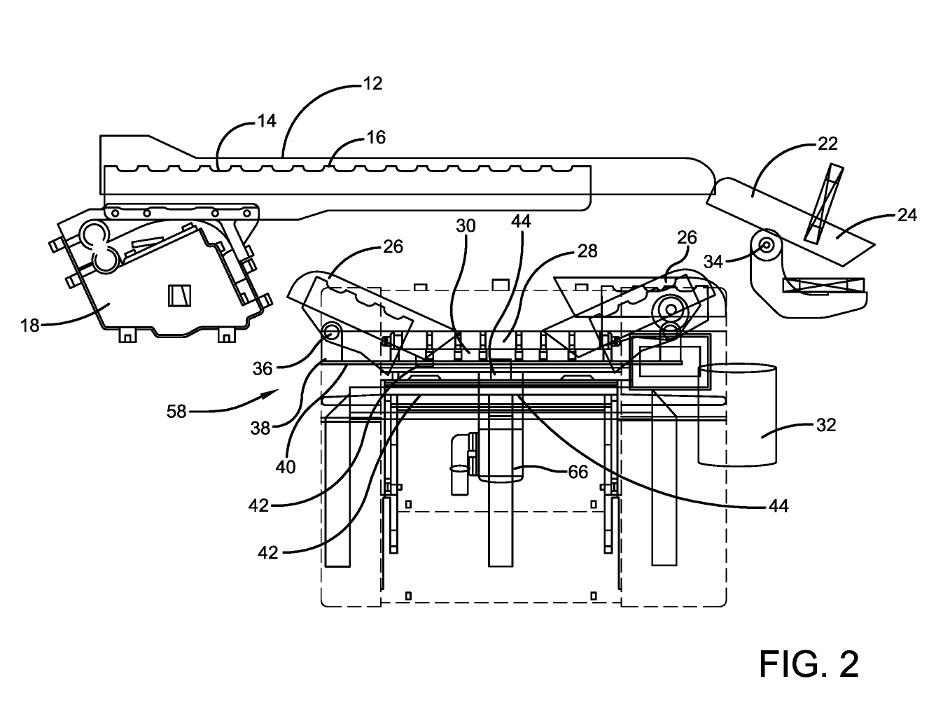

With reference to FIG. 1 and FIG. 2, the bulk article to be separated is loaded into a hopper (10). The bulk article then passes through an aperture at the bottom of the hopper (not shown) and falls onto a first tray (12) below the hopper (10). In certain embodiments, the first tray (12) includes a plurality of lateral indentations (14) forming a plurality of grooves (16). This first tray (12) is mechanically connected to a vibratory machine (18) which vibrates the first tray (12) according to a particular speed or frequency. The first tray (12) may be mechanically connected to the vibratory machine (18) by any suitable fastener (20) known to a person of suitable skill in the art. For example, a series of threaded bolts and nuts may be utilized to attach the first tray (12) to the vibratory machine (18). As the bulk article is separate by the hopper (10) and falls onto the first tray (12), vibratory forces from the first tray (12) cause the article to separate and distribute along the grooved portions of the first tray (12). In certain embodiments, the vibratory forces are such that the article may be separated and evenly distributed along the length of the first tray (12). In certain embodiments, the hopper (10) may also be connected to the vibratory machine (18). For example, the hopper (10) may be connected to the vibratory machine (18) by a post member (20) in certain embodiments. In such embodiments, vibrations imparted upon the hopper (10) from the vibratory machine (18) cause the bulk article placed within the hopper (10) to separate and fall through the aperture at the bottom of the hopper (10) onto the first tray (12). In other embodiments, the hopper (10) may include a mechanical device having a blade for chopping, cutting apart or separating the bulk article into smaller pieces prior to its passage through the hopper (10) into the first tray.

With continuing reference to FIG. 2, the first tray (12) may have a first end and a second end. The first end of the first tray (12) may be connected to the vibratory machine (18). A dump scale assembly (22) may be positioned adjacent to and below the second end of the first tray (12). After the bulk article is separated by the vibratory forces applied to the first tray (12), the bulk article may fall off the edge of the first tray (12) and received by a pivotable container (24) on the dump scale assembly (22). After a certain amount of bulk material falls into the container (24), the weight of the bulk material causes the container to begin to pivot along its axis (34). At full pivot, the weight of the bulk material causes the container to pivot downward allowing the bulk material to be dumped or to enter into at least one v-tray (26) (i.e., a second tray). The v-trays (26) are also connected to a vibratory machine (not shown). In certain embodiments, the v-trays may be connected to the same vibratory machine that is connected to the first tray (12). In other embodiments, v-tray is connected to a separate vibratory machine. Vibrational forces applied to the v-trays (26) cause the bulk material to further separate and begin the aligning process. In certain embodiments, the bulk material is aligned along channels present within the v-tray (26). After the bulk material is further separated and aligned within the v-tray (26), the bulk material is dumped or falls onto a third tray (28) (i.e., a lower tray). The third tray (28) is also connected to a vibratory machine (not shown) which causes it to vibrate. In certain embodiments, the third tray (28) may be connected to the same vibratory machine as the first and/or second tray. In other embodiments, the third tray (28) may be connected to a separate vibratory machine. The third tray (28) also contains variously sized channels (30) which allows graded, sorted and aligned product to pass through on its way to a load cell (not shown) which contains an attached bag (not shown) for packaging. The channel configuration on the third tray (28) (i.e., the distance between each side of the sorting channel) is in relationship with the width of the opening from the carousal to the packaging machine. The apparatus may further include a recirculation dump collection bucket (32) to retrieve excess product which does not pass through any of the channels (30) for packaging. Also, if product rides on the top portion of the channels (i.e., not within the channels), that product may be graded out as rejected product within recirculation dump collection bucket (32). Such excess product may, in certain embodiments, be the result of graded and sorted products being too large to pass through the variously sized channels (30). The weight of the rejected product may be captured and applied within the system as rejected product. If rejected product results in changes within the weight data of the packaged product, weight data may be recalculated and transferred through the printing instruction to the appropriate label to be applied on the packaged product.

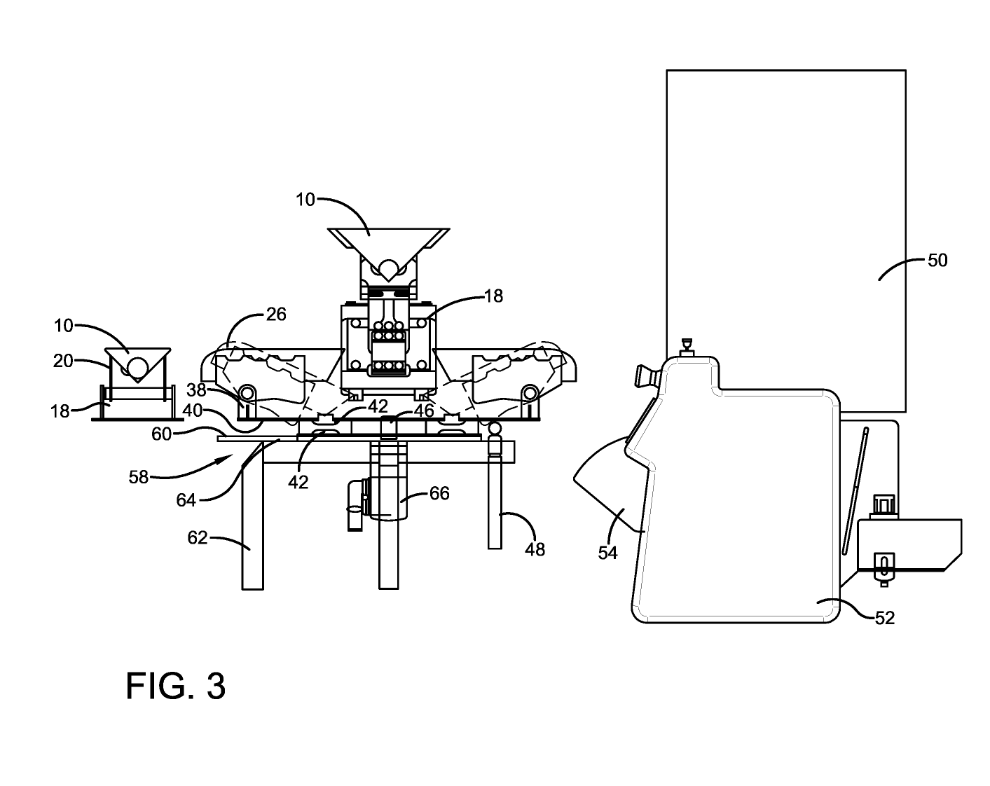

An alternative embodiment of the Automatic Grading, Sorting and Packaging System is illustrated within FIG. 3. With reference to FIG. 3, the apparatus may not include a dump scale assembly in certain embodiments. Rather the v-tray (26) may be pivotably connected along an axis (36) of a post member (38) which is connected to a bottom planar surface (40). Such v-trays (26) may receive graded and sorted product from the first tray. As the weight of the graded and sorted product received by the v-tray (26) increases, the inside end of the v-tray (26) begins to pivot downward until it contacts bumper rests (42) positioned on the bottom planar surface (40). In certain embodiments, the bottom planar surface (40) may consist of a rotary weldment and contain a center bore (44) having a hub (46). In other embodiments, the inside end of the v-trays (26) may allowed to pivot downward to contact the bumper rests (42) by retraction of a package dump air cylinder (48) which contacts the bottom side of the v-trays (26). After achieving their downward position, the v-trays (26) may begin to vibrate to separate and align the graded and sorted product.

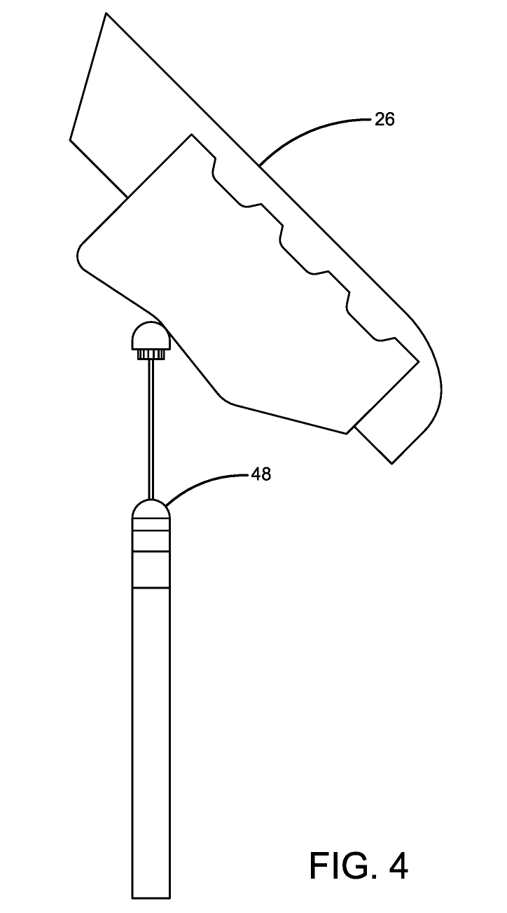

FIG. 3 further illustrates a label machine (50). The label machine (50) may be operated by software which instructs the label machine (50) to print package labels containing data with respect to the product being packaged. These labels are printed before the product is actually packaged. The label machine (50) is connected to a bagger machine (52). The label machine (50) and the bagger machine (52) work in conjunction to attach the labels to the bags to be packaged before product is placed therein. The bagger machine (52) includes an infeed chute (54) for receiving graded and sorted product from the v-trays (26). In order for the infeed chute (54) to receive the graded and sorted product from the v-trays (26), the v-trays are pivoted along the axis (36) so that the outside end of v-trays face downward towards the infeed chute (54). Pivoting of the v-trays (26) may be accomplished manually or mechanically. In certain embodiments, the v-trays (26) may be pivoted towards the infeed chute (54) by extension of a package dump air cylinder (48) which contacts the bottom side of the v-trays (26). An exemplary package dump air cylinder (48) is illustrated within FIG. 4. After the bagger machine (52) receives the product within its infeed chute (54), it proceeds with bagging and sealing the product within a labeled bag. The apparatus of FIG. 3 may rest upon a platform (58) comprising a top surface (60) and a plurality of legs (62). In certain embodiments, the top surface (60) of the platform (58) may include a wear strip (64) and various bumper rests (42). The hub (46) may connect the bottom planar surface (40) with the top surface (60) of the platform (58). In certain embodiments, a recirculation dump air cylinder (66) may be positioned below the hub (46) for collecting and recirculating unpackaged product materials which fall through the system.

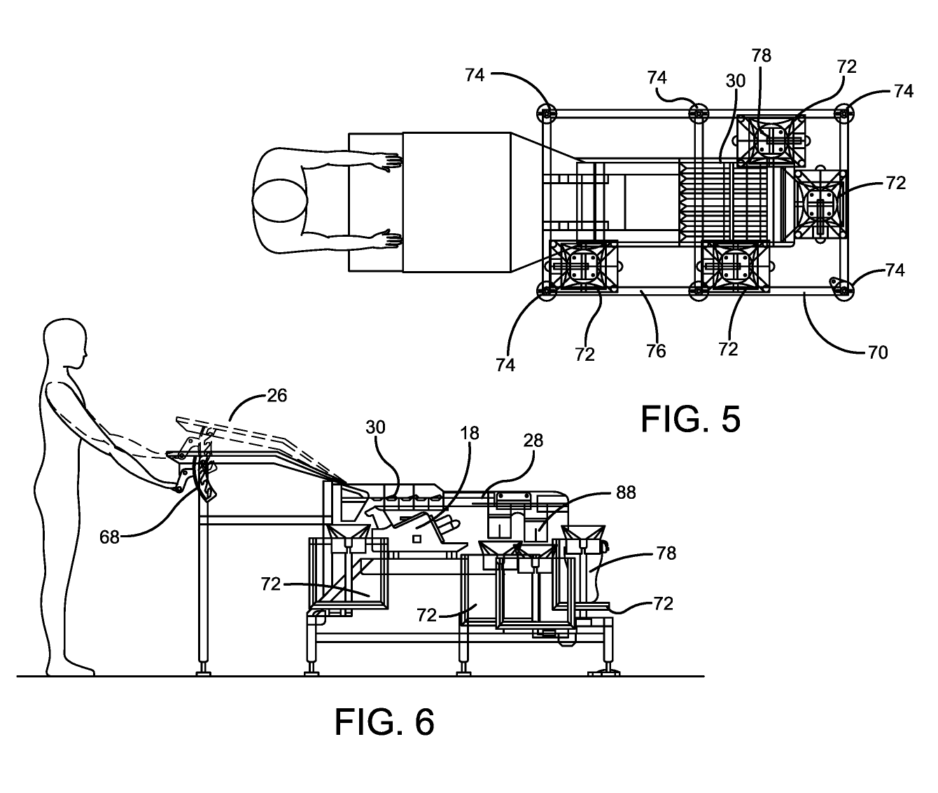

A further embodiment of the Automatic Grading, Sorting and Packaging System is illustrated within FIGS. 5 and 6. In this embodiment, the inside end of the v-trays (26) are attached to a pivot (38) along an axis (36). The v-trays (26) may then be pivoted so that the outside end of the v-trays (26) move upward and the inside end of the v-trays (26) move downward. Pivotal movement of the v-trays may be accomplished mechanically (e.g., by an air cylinder positioned below the v-tray which can contact the bottom surface of the v-tray) or manually as illustrated within FIGS. 5 and 6. In certain embodiments, the v-tray (26) may include a locking mechanism (68) to lock the v-tray (26) at various angles of elevation as it is pivoted along its axis (36). In certain embodiments, the locking mechanism (68) is a latching mechanism. As the v-trays (26) vibrate, graded and sorted product is aligned and further separated. Elevation of the v-trays then causes the separated and aligned product to enter a third tray (28) which may be referred to as a carousel tray (28). The third tray (28) includes a carousel (70) along its outer perimeter. The carousel (70) houses four different load cells (72) which may be encircle the third tray (28) by a wheel (74) and a conveyor (76) assembly of the carousel (70). A non-limiting example of a conveyor (76) may include a belt. Although only four load cells (72) are illustrated within FIG. 5, the apparatus may be designed to incorporate the use of any number of load cells (72). Within each load cell (72) is a bag (78) which receives product which falls or is dumped from the third tray (28). Each load cell (72) further includes a scale which weighs product as it is received from the third tray (28). In certain embodiments, the third tray (28) may include various channels (30). The channels (30) may be of different sizes for receiving product which is separated into different sizes. In certain embodiments, the channels (30) may be sloped downward from a first end of the third tray (28) to a second end of the third tray (28) to allow product to fall into an appropriately positioned bag (78). The load cells (72) are aligned with the channels (30) in a position which is lower than the channels (30) to receive product from the third tray (28). In one exemplary embodiment, where the apparatus includes four load cells (72) within the carousel (70), the third tray (28) may also include four channels (30) for each load cell (72). In certain embodiments the channels (30) may be v-shaped and be referred to as v-channels. In further embodiments, the channels (30) may be parallel to each other.

The apparatus illustrated within FIG. 6 further includes a support structure (94) having a various legs (96), a lower platform (98) for housing the loading cells (72) and an upper platform (100) for housing the vibratory machine (18). The vibratory machine (18) is connected to the third tray (28) containing variously sized channels (30) for sorting and aligning variously sized product through chutes (88). Positioned below the chutes (88) are load cells (72). The load cells (72) contain bags (78) for receiving the graded and sorted product. As illustrated within FIG. 6, the load cells (72) may be positioned at different heights relative to each other. In addition, the load cells (72) may contain a sensor (92) positioned below the bottom surface of the load cell (72) for sensing the weight of product as it enters the bag (78).

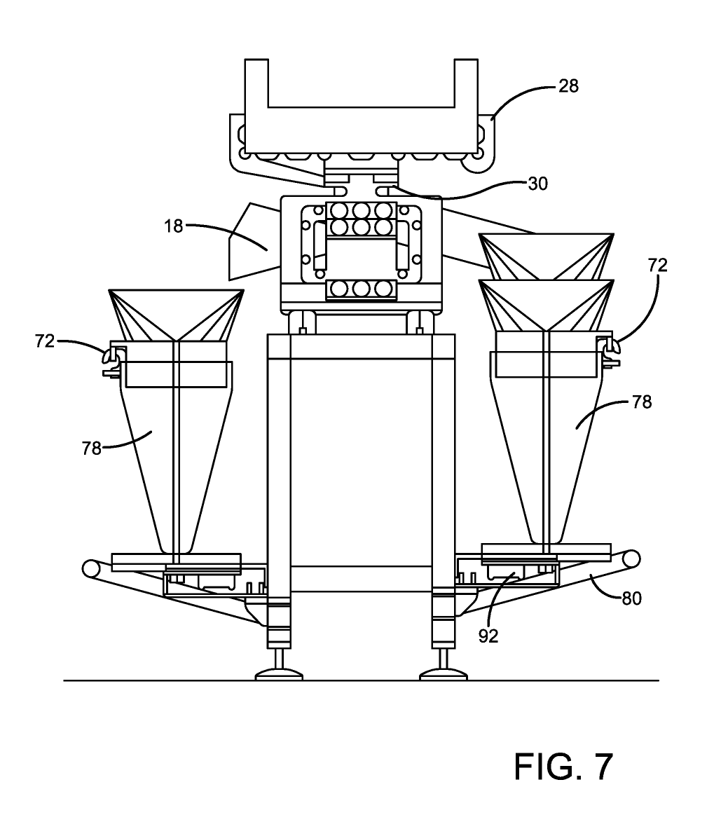

In an alternative embodiment illustrated within FIG. 7, the third tray (28) may be connected to a vibratory machine (18) which, in addition to providing vibrational motion, may cause the third tray (28) to rotate or pivot along an axis. This rotation or pivoting of the third tray (28) may be used to cause graded and sorted product to fall through the channels (30) from within the third tray (28) into a bag (78) positioned within a load cell (72). In certain embodiments, the load cell (72) may further include a scale to weigh product as it enters a bag (78) positioned within the load cell (72). In certain embodiments, as product enters the bag (78) it may cause a lever (80) positioned below the load cell (72) to pivot in a downward motion. This movement of the lever (80) may be used to register the weight of the product as it enters the bag (80).

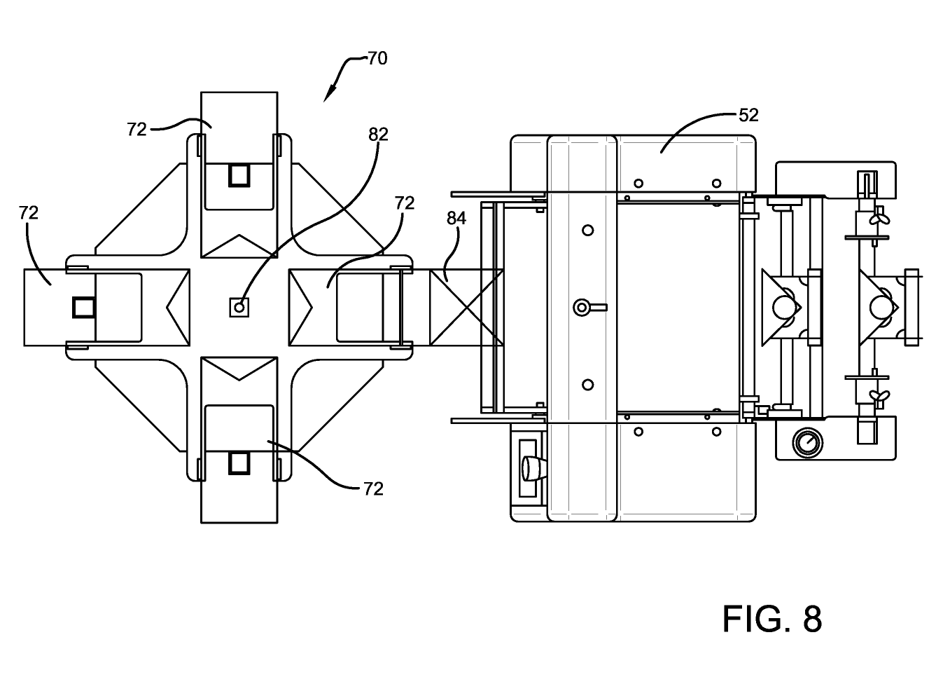

An alternative embodiment of the carousel (70) is illustrated within FIG. 8. The carousel (70) within FIG. 8 includes four load cells (72). Within each load cell (72) is a bag (78). The carousel (70) rotates about a center axis (82) by a rotary machine (not shown) positioned below the carousel (70). Also illustrated within FIG. 8 is a bagger machine (52). The bagger machine (52) includes a dump window (84) through which a bag (78) is exported. As the bagger machine (52) exports a bag (78), the carousel (70) rotates so that a load cell (72) is aligned with the dump window (84) of the bagger machine (52). The load cell (72) then receives the bag (78) through the dump window (84) allowing the load cell (72) to receive graded and sorted product.

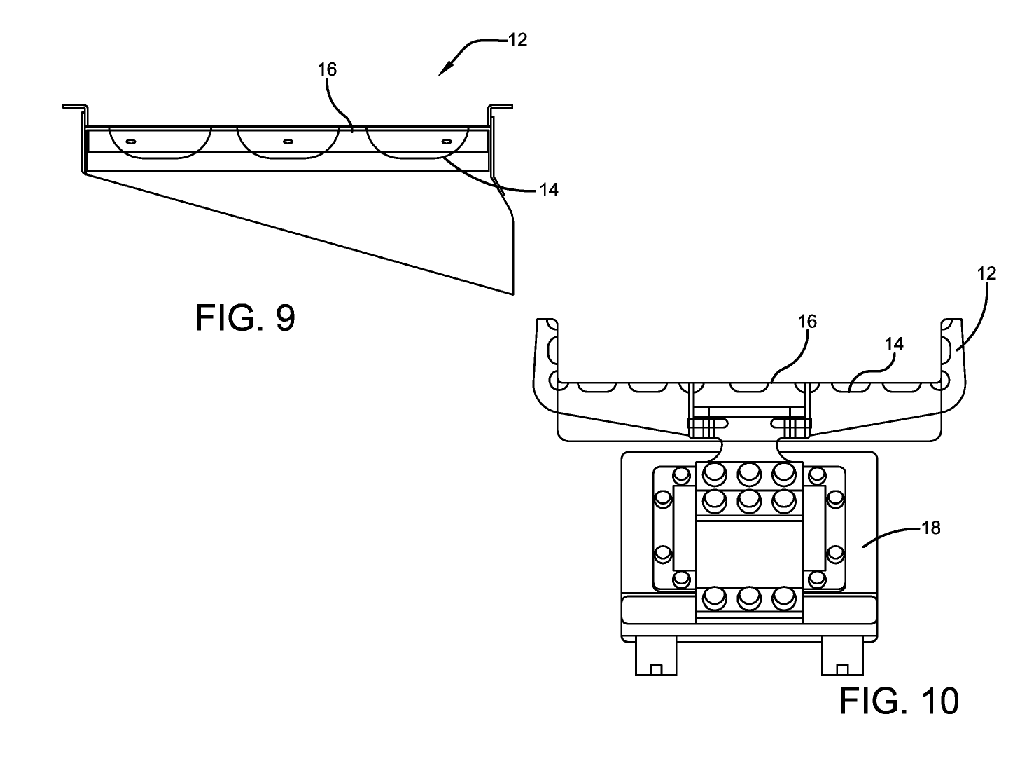

FIG. 9 illustrates an exemplary embodiment of the infeed end of the Automatic Grading, Sorting and Packaging System as one would view with the flow of bulk product through the system. As illustrated within FIG. 9, the first tray (12) includes a plurality of lateral indentations (14) forming a plurality of grooves (16). These grooves (16) facilitate the breaking apart, grading and sorting of bulk material as it passes through the system. FIG. 10 illustrates the infeed end of an exemplary embodiment of the Automatic Grading, Sorting and Packaging System illustrated within FIG. 9 which is connected to a vibratory machine (18).

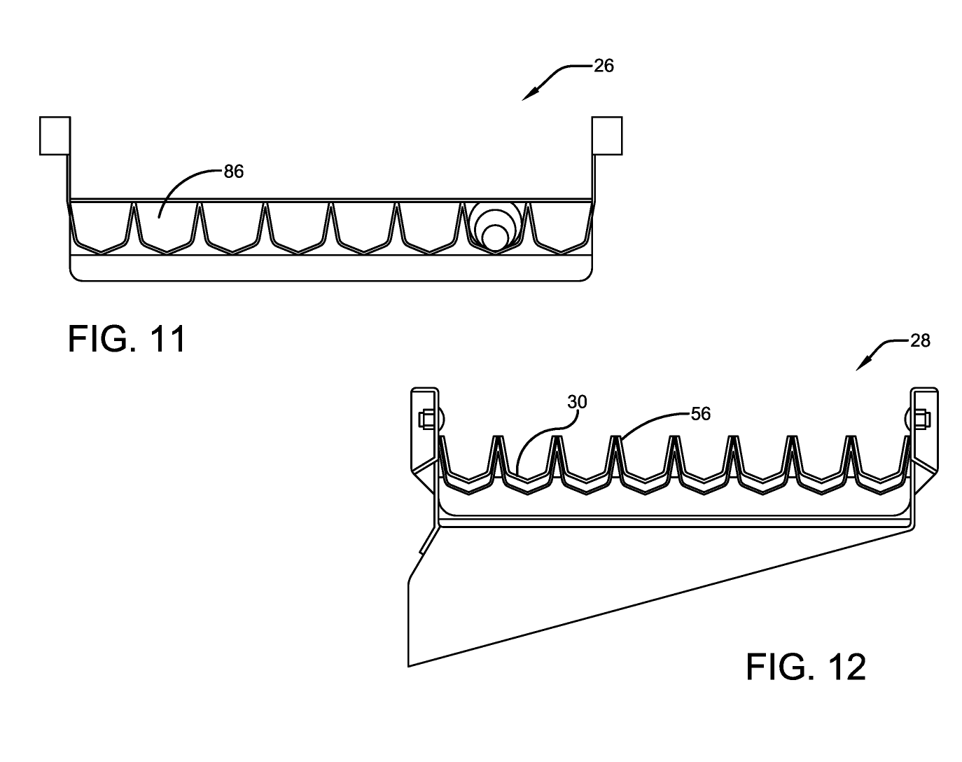

FIG. 11 illustrates a sectional view of an exemplary embodiment of the v-tray (26) of the Automatic Grading, Sorting and Packaging System as one would view with the flow of product through the system. As illustrated within FIG. 11, the v-tray (26) includes a plurality of lateral channels (86). These channels (86) may facilitate the breaking apart, grading, sorting and aligning of product as it passes through the system. In certain embodiments, these channels (86) may include aligning fins (not shown) which project vertically upward from the bottom surface of the v-tray (26).

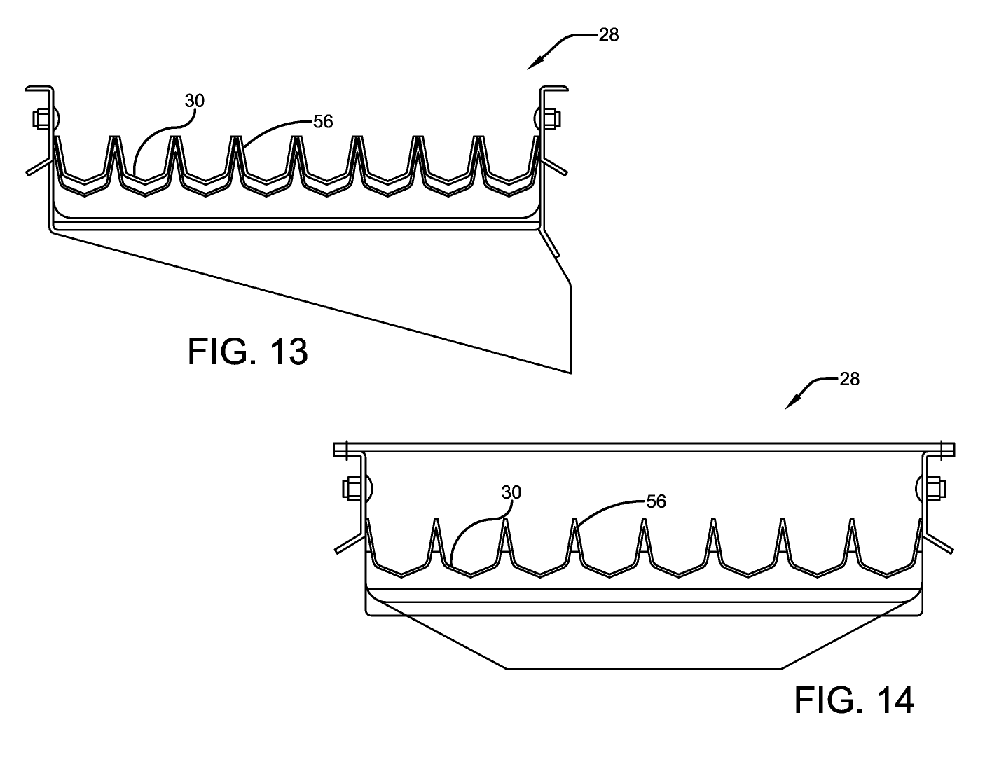

FIG. 12 illustrates a sectional view of the front end of an exemplary third tray (28) as one would view with the flow of product through the system. As illustrated within FIG. 12, the third tray (28) includes a plurality of channels (30) formed by a plurality of vertical projections (56) extending from the interior surface of the v-tray. These channels (30) may ensure that graded and sorted product having an appropriate size (e.g., width and girth) for passage through the opening of the bag (78), are passed through the system for packaging. FIG. 13 illustrates a sectional end view of an exemplary embodiment of a third tray (28) of the Automatic Grading, Sorting and Packaging System as one would view with the flow of bulk product through the system. As illustrated within FIG. 13, the third tray (28) includes a plurality of lateral channels (30) formed from vertical projections (56) which extend upward from the bottom surface of the third tray (28). FIG. 14 illustrates an elevated view of the discharge end of an exemplary embodiment of the third tray (28). The third tray (28) includes a plurality of channels (30) formed from vertical projections (56) which extend upward from the bottom surface of the third tray (28).

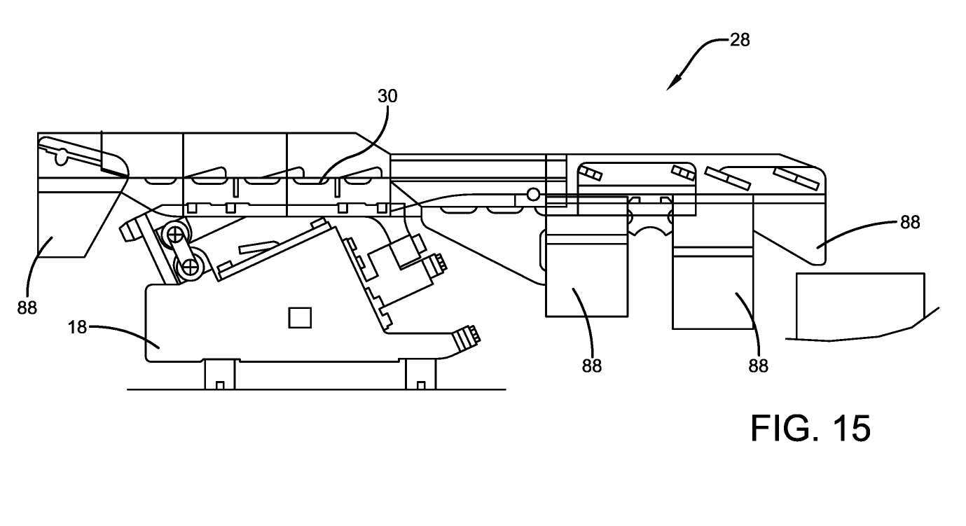

FIG. 15 illustrates a side elevated view of an exemplary embodiment of the Automatic Grading, Sorting and Packaging System. Shown within FIG. 15 is the third tray (28). Also shown within FIG. 15 is the vibratory machine (18) which is mechanically fastened (e.g., by nuts and bolts, although any type of mechanical fastener suitable to one of skill in the art may be used) to the third tray. Adjacent to the third tray (28) are chutes (88) through which graded and sorted product can pass through from the third tray (28). These chutes (88) typically contain a bag (not shown) for receiving the graded and sorted product from the third tray (28).

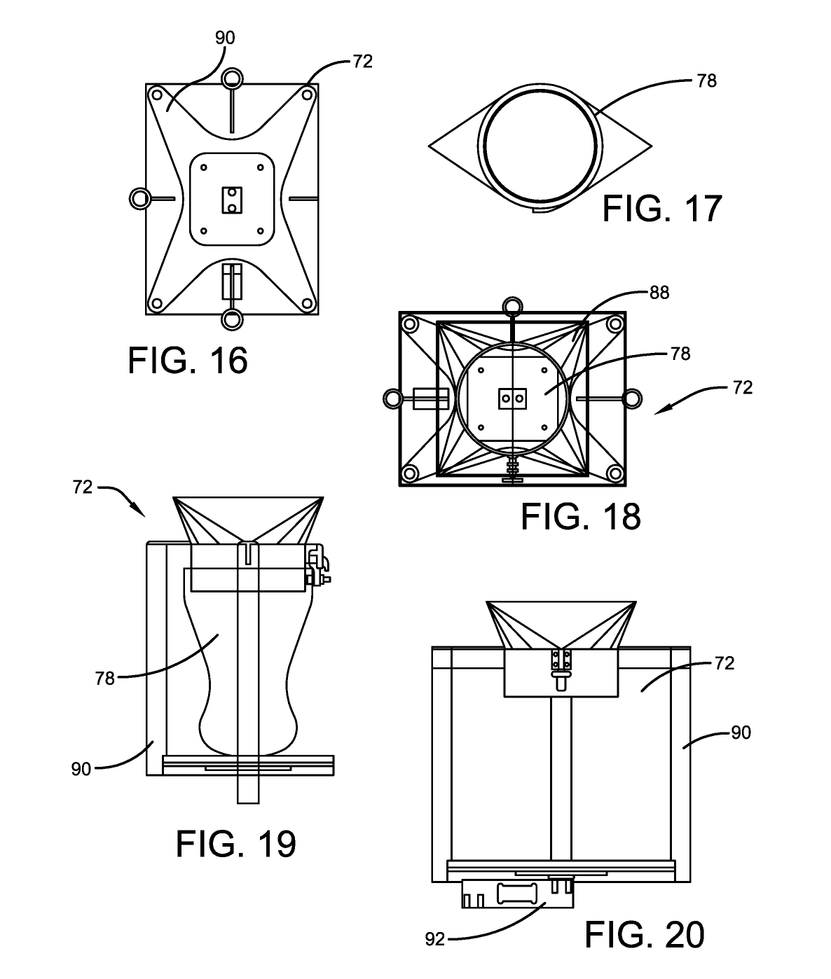

FIGS. 16 through 20 are various views of an exemplary load cell (72) and bag (78) which may be used in an exemplary embodiment of the Automatic Grading, Sorting and Packaging System. FIG. 16 is an overhead sectional view of an exemplary load cell (72) containing a frame (90) for housing a bag (not shown). An infeed funnel (not shown) is typically positioned above the load cell (72) of FIG. 16. FIG. 17 an overhead sectional view of an exemplary bag (78) which may be inserted within the load cell (72) illustrated within FIG. 16. FIG. 18 is an overhead sectional view of an exemplary load cell (72) containing a bag (78) attached therein. FIG. 19 is a side sectional view of an exemplary load cell (72) containing a bag (78) attached therein. FIG. 20 is a side view of an exemplary load cell (72) containing a bag (78) attached therein. Below the load cell (72) is a sensor (92) which is used to register the weight of product as it enters the bag (78).

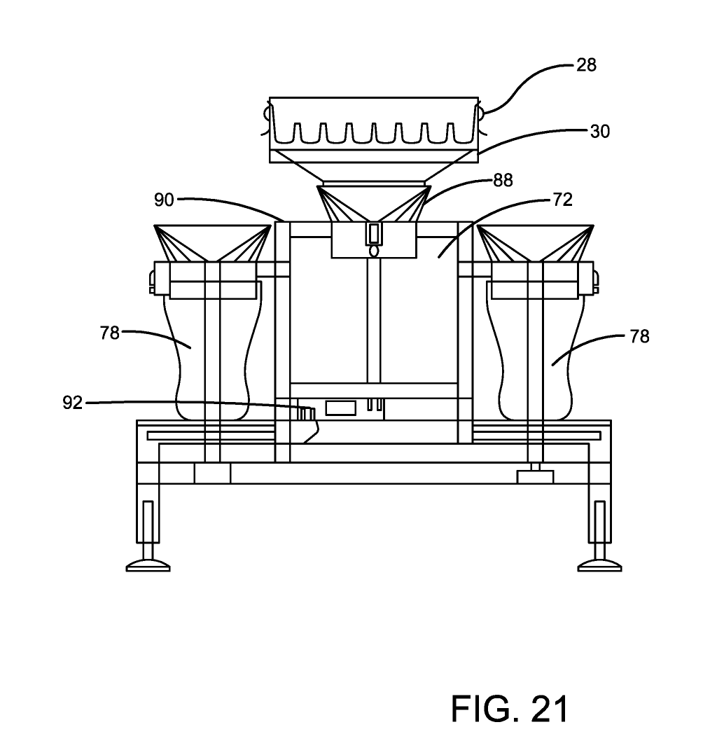

FIG. 21 illustrates an exemplary embodiment of the third tray (28) of the Automatic Grading, Sorting and Packaging System. The third tray (28) includes vertical projections (86) which extend upward from the bottom surface of the third tray (28) which are used to grade and sort product to fall through the channels (30) from within the third tray (28) into a bag (78) positioned within a load cell (72).

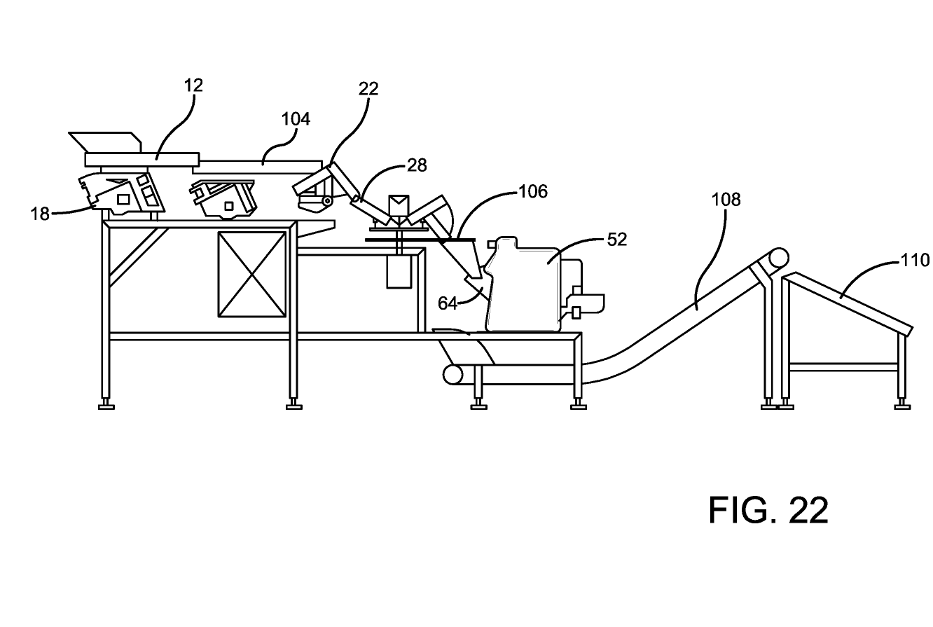

FIG. 22 is a side view of an alternative embodiment of the Automatic Grading, Sorting and Packaging System. Various components of the Automatic Grading, Sorting and Packaging System are positioned at various points along a support structure (94). As illustrated within FIG. 22, the process of grading and sorting within the system begins by placing bulk product within an infeed hopper (10). In certain embodiments, the infeed hopper may have a round bar grate (102). The bulk product exits the hopper (10) and enters a first tray or conveyor (12). A vibratory machine (18) is positioned below and connected to the first tray (12). The vibratory machine (18) causes the first tray (12) to vibrate to separate the product. In certain embodiments, the first tray (12) may be positioned at an incline to assist in separating the bulk material into single pieces before discharge from the first tray (12). In other embodiments, the first tray may be substantially horizontally oriented. After passing through the first tray (12), the product may be discharged onto a conveyor (104) which is positioned below the first tray (12). In certain embodiments, the conveyor (104) is a v-tray feeder conveyor. A vibratory machine (18) is positioned below the conveyor (104) which causes the conveyor (104) to vibrate to further separate the product. After passing through the conveyor (104), the product enters a dump scale assembly (22) which comprises a container (24) pivotable along an axis. As product enters the dump scale (22), the weight of the product causes the container (24) to pivot along the axis so that the second end of the container (24) faces downward towards the v-trays (26) which are positioned below the conveyor (104) and the dump scale assembly (22). As a result of the pivotable movement of the container (24), the product flows from the container (24) onto the v-tray (26). The container (24) on the dump scale assembly (22) then pivots to its original position wherein its first end faces downward. Pivoting of the container (24) of the dump assembly (22) to its original position may be accomplished by a biasing device such as a spring (not shown). After receiving the product, the v-trays (26) vibrate through forces applied by a vibratory machine (18) to further separate and align the product. The vibratory machine (18) may then cause the v-tray (26) filled with product to rotate along a carousel (70) to align with a bagger feed chute (106) on a bagger machine (52). The v-tray (26) may then be rotated along a pivot point so that product may flow from the v-tray (26) into the bagger feeder chute (106) of a bagger machine (52). Rotation of the v-tray (26) along the pivot point may be accomplished manually or mechanically (e.g., a piston positioned below the v-tray). After entering the bagger feed chute (106), the bagger machine (52) will bag the product and dispel the bagged product on a take away conveyor (108). The take away conveyor (108) will transport the product to a packing table (110) wherein the product may be further packaged by individual(s).

In certain embodiments, the carousel may have a secondary dump sequence designed for hand packaging rejected product or for hand packaging product after the grading and sorting process has halted. In such embodiments, the carousel can be considered to comprise four stages with the first stage consisting of receiving the weighted product and the fourth stage consisting of the weighted product being dumped into the alignment shoot to the packaging machine. In such embodiments, the third stage or position of the carousel may be used to feed a hand packaged process or another type of packaging process.

In certain embodiments, the disclosed Automatic Grading, Sorting and Packaging System may be utilized in conjunction with tracking software run on a computer. The computer includes a processing system capable of executing various instructions or steps received from the software. The software may be used to record data related to the bulk material product from entry within the system until discharge and packing of the final graded and sorted product. Upon receiving inventory at a load station, a user of the software within the system may enter data related to the farm or location of purchase of the bulk material product, the weight of the product, the date and time of receipt of the bulk material product, the date and time of purchase of the bulk material product, the order number of the bulk material product, the specific type or strain of bulk material product, an employee identification number of the user entering the data and performing the grading and sorting, the purchase code of the bulk material product, comments, the brand name of the bulk material product purchase, the estimated time to market of the bulk material product, the price paid per pound or unit of the bulk material product, etc. The received bulk material product may then be subject to quality control and grade where it may be further scaled. The software may instruct the computer processor to save this inventory data within the internal memory of the computer. Subsequently, the software may instruct the computer processor to upload this inventory data to be posted on a retailer's website. The bulk material product may then be sorted into various grade sizes. Information related to grade size, load identification and grade weight as well as other information is entered into the software. The software may instruct the computer processor to save this data within the internal memory of the computer. Subsequently, the software may instruct the computer processor to upload data related to the various grades for posting on a retailer's website as processed inventory. This processed inventory data includes the brand name of the product, the estimated time to market, the estimated volume of product in stock, the estimated price per unit of product and order information of the product. After the product is sorted into various grades it is further scaled, processed through the feeder system, packaged and labeled. The software instructs the computer processor to track the product as it is fed through the feeder system, packaged and labeled into a particular product form (e.g., a cigarette or an edible), store this data within the internal memory of the computer and upload the data related to available inventory for purchase for posting on the retailer's website. Such information includes the brand name of the product, the volume of product available, the price per unit of product and order information. The package may include a label having a bar code or quick release (QR) code which may contain product information embedded therein. This code may be scanned by a scanner within the system. The software may receive and decode the scanned information and instruct the computer processor to save this data within the internal memory of the computer. Subsequently, the software may instruct the computer processor to upload this data to be posted on a retailer's website. Thus, the software permits the uploading of product purchasing information on the retailer's website. Customers may access the retailer's website for offers to purchase various products. In addition farms selling bulk material product may access the website to view price offers for purchasing bulk material products by the retailer or distributor. After an order is placed by the customer or an offer accepted by a farm, the software may set instructions in place through the computer processor to arrange for transportation of product and set a delivery time and place.

In other embodiments, specific identification numbers or codes of the various variables related to any type of inventory data (including inventory data described above) may be generated and linked with the actual weight data assigned to a particular load cell within the system (this process may be applied to all load cells within the system). The identification numbers or codes may then be processed through software and printed on a corresponding label assigned to the specific package being produced. This process may be repeated in each of the four zones of data generation which include receiving product, grading and sorting product, packaging product and shipping product.

The Automatic Grading, Sorting and Packaging System may be used to grade, sort and package any food product such as fruits, vegetables, plants, parts of plants, herbs, grains, tobacco, beans (including but not limited to coffee beans), seeds, medicines and anything that may be ground chopped, sliced or separated into different sizes. In certain embodiments, the Automatic Grading, Sorting and Packaging System may be used to grade, sort and package cannabis. The presently disclosed system may be used to package cannabis in the form of leaves and herbs. In certain embodiments, the bag used to package products processed through the Automatic Grading, Sorting and packaging System is a polypropylene bag.

Numerous embodiments have been described herein. It will be apparent to those skilled in the art that the above systems, devices and methods may incorporate changes and modifications without departing from the general scope of this invention. It is intended to include all such modifications and alterations in so far as they come within the scope of the appended claims or the equivalents thereof. The phrase “associated with” as used in this document refers to structures which support the disclosed systems, devices and methods and may also refer to structures not disclosed herein capable of supporting the disclosed systems, devices and methods. Further, the “invention” as that term is used in this document is what is claimed in the claims of this document. The right to claim elements and/or sub-combinations that are disclosed herein as other inventions in other patent documents is hereby unconditionally reserved.

Having thus described the disclosed system and method, it is now claimed:

What is claimed is:

1. An automatic grading, sorting and packaging system comprising:
a receiving load cell for weighing an incoming bulk article to be inventoried;
a hopper which receives the incoming bulk article for grading and sorting;
a first tray positioned under the hopper, which receives the bulk article as it passes through the hopper, wherein the first tray includes a plurality of indentations which form a plurality of grooves within the first tray;
a second tray positioned below the first tray, which receives graded and sorted product from the first tray, wherein the second tray includes a plurality of indentations which form a plurality of grooves within the tray;
a third tray positioned below the second tray, wherein the third tray comprises variously sized channels allowing graded and sorted product having a size within the dimensions of the channels to enter into the channels;
at least one vibratory machine connected to at least one of the first tray, the second tray and the third tray which causes at least one of the first tray, second tray and third tray to vibrate;
a carousel housing at least two or more load cells positioned below the third tray, wherein the load cells contain a bag positioned therein for receiving graded and sorted product from a particularly sized channel of the third tray and wherein the load cells further comprise a sensor for weighing graded and sorted product placed within the bag;
a bagger machine for disposing bags within the load cells on the carousel prior to disposal of the product from the channels of the third trays in the load cell; and
a label machine for applying data related to the inventoried bulk article and the graded and sorted product onto a label which is applied to bags prior to disposal of the bags by the bagger machine onto the load cell of the carousel, wherein inventory data is encoded on the label through one of the following: an identification number, a bar code and a quick release code.

2. The automatic grading, sorting and packaging system of claim 1, wherein the forces applied by the at least one vibratory machine are micro-vibratory forces.

3. The automatic grading, sorting and packaging system of claim 2, wherein the first tray is positioned at an incline.

4. The automatic grading, sorting and packaging system of claim 3, wherein a dump scale assembly is positioned below the first tray to receive graded and sorted product falling off the first tray, further wherein the dump scale assembly comprises a container which is pivotable along an axis so that the weight of the graded and sorted product entering into the retainer causes the retainer to pivot and dump the graded and sorted product onto the second tray.

5. The automatic grading, sorting and packaging system of claim 4, wherein the second tray comprises a v-tray which is pivotable along an axis.

6. The automatic grading, sorting and packaging system of claim 1, wherein the second tray is a v-tray having an interior end and an outer end, wherein the v-tray receives graded and sorted product directly from the first tray and wherein the v-tray is pivotable along an axis so that the weight of the graded and sorted product entering the v-tray causes the v-tray to pivot along the axis so that the interior end of the v-tray is pivoted in a downward position.

7. The automatic grading, sorting and packaging system of claim 1, wherein the first tray vibrates at a rate slower than the second tray and the third tray.

8. The automatic grading, sorting and packaging system of claim 7, wherein the second tray vibrates at a rate which is twice as fast as the third tray in order to further separate and align the graded and sorted product.

9. The automatic grading, sorting and packaging system of claim 1, wherein the channels within the third tray are v-shaped.

10. The automatic grading, sorting and packaging system of claim 9, wherein the v-shaped channels are angled downward from a first end of the third tray to a second end of the third tray allowing the graded and sorted product to pass through the channels and into the load cell containing the bag for packaging.

11. The automatic grading, sorting and packaging system of claim 9, wherein the third tray is pivotable along an axis to allow graded and sorted product to pass through the channels within the third tray into the bag positioned within the load cell.

12. The automatic grading, sorting and packaging system of claim 1, wherein the graded and sorted product which is passed through the channel has a size which permits entry within a bag opening without causing bridging of the graded and sorted product within the channel.

13. The automatic grading, sorting and packaging system of claim 12, wherein the graded and sorted product which is passed through the channel has a width and girth which permits entry within a bag opening without causing bridging of the graded and sorted product within the channel.

14. The automatic grading, sorting and packaging system of claim 1, wherein the third tray comprises four channels.

15. The automatic grading, sorting and packaging system of claim 14, wherein the four channels have a width of one inch, two inches, three inches and four inches respectively.

16. The automatic grading, sorting and packaging system of claim 15, wherein the carousel comprises four load cells each of which may be positioned under the four channels respectively.

17. The automatic grading, sorting and packaging system of claim 1, wherein the labeling device operates by creating labels for up to three bags ahead from the current label being applied to a bag within the system.

18. An automatic grading, sorting and packaging system comprising:
a receiving load cell for weighing an incoming bulk article to be inventoried;
a hopper which receives the incoming bulk article for grading and sorting;
a first tray positioned under the hopper, which receives the bulk article as it passes through the hopper, wherein the first tray includes a plurality of indentations which form a plurality of grooves within the first tray;
a second tray positioned below the first tray, which receives graded and sorted product from the first tray, wherein the second tray includes a plurality of indentations which form a plurality of grooves within the tray;
a third tray positioned below the second tray, wherein the third tray comprises variously sized channels allowing graded and sorted product having a size within the dimensions of the channels to enter into the channels;
at least one vibratory machine connected to at least one of the first tray, the second tray and the third tray which causes at least one of the first tray, second tray and third tray to vibrate;
a carousel housing at least two or more load cells positioned below the third tray, wherein the load cells contain a bag positioned therein for receiving graded and sorted product from a particularly sized channel of the third tray, further wherein the graded and sorted product passed through the channel has a size which permits entry within a bag opening without causing bridging of the graded and sorted product within the channel;
a bagger machine for disposing bags within the load cells on the carousel prior to disposal of the product from the channels of the third trays in the load cell; and
a label machine for applying data related to the inventoried bulk article and the graded and sorted product onto a label which is applied to bags prior to disposal of the bags by the bagger machine onto the load cell of the carousel, wherein inventory data is encoded on the label through one of the following: an identification number, a bar code and a quick release code.

19. A method for automatic grading, sorting and packaging system comprising:
receiving a bulk article to be inventoried and measuring the weight of the bulk article on a receiving load cell;
inserting the bulk article within a hopper for separating the bulk article into smaller pieces;
allowing the bulk article to pass through an aperture at a bottom portion of the hopper to fall on a first tray positioned under the hopper, wherein the first tray includes a plurality of indentations which form a plurality of grooves within the first tray;
applying vibratory forces to the first tray allowing the bulk article to be separated along the grooves within the first tray into graded and sorted product, wherein the vibratory forces on the first tray cause the graded and sorted product to travel towards a second tray;
allowing the graded and sorted product to fall onto a second tray positioned below the first tray, wherein the second tray includes a plurality of indentations which form a plurality of grooves within the tray for further separation and alignment of the graded and sorted product, applying vibratory forces to the second tray allowing the graded and sorted article to be further separated along the grooves within the second tray and wherein the vibratory forces on the second tray cause the graded and sorted product to travel towards a third tray;
allowing the graded and sorted product to fall onto a third tray positioned below the second tray, wherein the third tray includes a plurality of variously sized channels;
applying vibratory forces to the third tray allowing the graded and sorted product having a size within the dimensions of a particular channel to enter into the channel and fall towards a load cell positioned below the channel, wherein at least two load cells are positioned within a carousel below the third tray and a bag within the load cells receives graded and sorted product having a size which permits entry within an opening of the bag without causing bridging of the channel;
recording the weight of the graded and sorted product within the bag in the load cell through use of a sensor within the load cell;
allowing the carousel to rotate the load cell when it is filled to the appropriate pre-set weight and position a subsequent load cell under the channel;
removing the bag filled with graded and sorted product from the load cell on the carousel thereby rendering the load cell empty;
using a label machine for applying data related to the inventoried bulk article and the graded and sorted product onto a label and applying the label to a bag prior to disposal of the bag by the bagger machine onto the empty load cell on the carousel, wherein inventory data is encoded on the label through one of the following: an identification number, a bar code and a quick release code; and
rotating the carousel so that the load cell without a bag is positioned adjacent a dump window on a bagger machine and allowing the bagger machine to dispose a bag within the empty load cell on the carousel prior to disposal of the product from the channels of the third trays in the load cell.
